(19) United States
(12) Patent Application Publication
(10) Pub. No.: US 2018/0239322 A1
(43) Pub. Date: Aug. 23, 2018

(54) INFORMATION CREATION METHOD, STORAGE MEDIUM, INFORMATION CREATION DEVICE, AND INFORMATION CREATION SYSTEM

(71) Applicant: PANASONIC INTELLECTUAL PROPERTY MANAGEMENT CO., LTD., Osaka (JP)

(72) Inventors: Nobuo MATSUO, Hyogo (JP); Satoshi TSUJIMURA, Hyogo (JP); Yanfeng WANG, Osaka (JP); Yoshifumi MURAKAMI, Osaka (JP)

(21) Appl. No.: 15/748,064

(22) PCT Filed: Jul. 28, 2016
(86) PCT No.: PCT/JP2016/003489

§ 371 Date: Jan. 26, 2018

(30) Foreign Application Priority Data
Jul. 28, 2015 (JP) 2015-148925

(51) Int. Cl. G05B 17/02

(52) U.S. Cl. CPC G05B 17/02

(57) ABSTRACT

An information creation method for use in an information creation device includes the steps of: receiving building model data, such as BIM data, including information about architecture of a building and information about equipment, such as lighting equipment, of the building; and receiving input data in association with the building model data. The input data defines a condition for creating control data for controlling the equipment.

### RELATED APPLICATIONS

This application is the U.S. National Phase under 35 U.S.C. § 371 of International Patent Application No. PCT/JP2016/003489, filed on Jul. 28, 2016, which in turn claims the benefit of Japanese Application No. 2015-148925, filed on Jul. 28, 2015, the entire disclosures of which Applications are incorporated by reference herein.

### TECHNICAL FIELD

The present invention generally relates to information creation methods, storage media, information creation devices, and information creation systems, and more particularly relates to an information creation method, storage medium, information creation device, and information creation system for creating control data for equipment installed in a building.

### BACKGROUND ART

A building management system for applying building models, covering the shapes, positions, and specifications of structure building blocks that form a building, to an environmental management system for monitoring the environmental information of the building and controlling the devices of the building has been proposed in the art (see, for example, Patent Literature 1). The environmental management system is built based on information about the specifications of the devices included in the building models. Patent Literature 1 adopts building information modeling (BIM) as the building models.

According to Patent Literature 1, however, the environmental management system just takes advantage of such information about the specifications of the devices included in the building models in controlling or monitoring the devices of the building. Patent Literature 1 fails to disclose a technique for using the building models to create control data required for controlling the devices.

### CITATION LIST

### Patent Literature

Patent Literature 1: JP 2013-125330 A

### SUMMARY OF INVENTION

It is therefore an object of the present invention to provide an information creation method, storage medium, information creation device, and information creation system for creating control data for equipment based on building model data.

An information creation method according to an aspect of the present invention includes the steps of: receiving building model data including information about architecture of a building and information about equipment of the building; and receiving input data in association with the building model data. The input data defines a condition for creating control data for controlling the equipment.

A storage medium according to another aspect of the present invention has stored thereon a program configured to make a computer execute the steps of: receiving building model data including information about architecture of a building and information about equipment of the building; and receiving input data in association with the building model data. The input data defines a condition for creating control data for controlling the equipment.

An information creation device according to still another aspect of the present invention includes an input/output interface, an input interface, a processing device, and an output interface. The input/output (I/O) interface is configured to receive building model data including information about architecture of a building and information about equipment of the building. The input interface is configured to receive input data in association with the building model data. The input data defines a condition for creating control data for controlling the equipment. The processing device is configured to create the control data based on the building model data and the input data. The output interface is configured to output the control data created by the processing device.

An information creation system according to yet another aspect of the present invention includes an input/output interface, an input interface, a processing device, and an output interface. The input/output interface is configured to receive building model data including information about architecture of a building and information about equipment of the building. The input interface is configured to receive input data in association with the building model data. The input data defines a condition for creating control data for controlling the equipment. The processing device is configured to create the control data based on the building model data and the input data. The output interface is configured to output the control data created by the processing device.

An information creation system according to yet another aspect of the present invention includes: the information creation device described above; and a simulator configured to simulate operation of the equipment based on the control data in virtual space built by a computer.

The configuration of the present invention enables control data to be created for equipment based on building model data.

### BRIEF DESCRIPTION OF DRAWINGS

FIG. 1 is a block diagram illustrating an embodiment;

FIG. 2 is flowchart showing the procedure of creating data according to an embodiment;

FIG. 3 illustrates how a target space may be displayed according to an embodiment; and

FIG. 4 shows a concept of a data generation process according to an embodiment.

### DESCRIPTION OF EMBODIMENTS

A technique for creating control data for controlling equipment installed in a building based on building information modeling (BIM) data (hereinafter referred to as “BIM data”), which is a type of building model data, will be described in the following description. The control data for the equipment is created by an information creation device, which is implemented by making a computer execute a program. Therefore, in the following description, an information creation device configured with a computer and a program designed to make a computer function as an information creation device will be described. In addition, a method for creating control data based on the BIM data and a program for making a computer carry out the method will also be described.

BIM is a technology for rendering a building in virtual space built by using a computer. BIM data is a collection of various types of data comprehensively including not only data representing the shape and dimensions of a building, such as three-dimensional computer aided design (CAD) data, but also data about individual members of the building and data about equipment installed in the building as well. That is to say, the BIM data refers herein to a collection of various types of data related to a building.

In the following description, a computer that executes a program for creating the BIM data will be hereinafter referred to as a “modeling device.” The modeling device does not have to be implemented as a single computer but may also be implemented as a plurality of computers. In the latter case, multiple different types of data may be created by those computers separately from each other.

Alternatively, the modeling device may also be comprised of a server and a terminal device (client device). In that case, the program for creating the BIM data is executed by the server, and the user is allowed to use the server's program with the terminal device to create the BIM data. The server and the terminal device suitably communicate with each other over a telecommunications line such as the Internet. The server, implemented in the form of software as a service (SaaS), allows the user to use the program. The server does not have to be implemented as a single computer but may also be comprised of a plurality of computers. Alternatively, the server may be configured as a cloud computing system as well.

Although the building is herein supposed to be an office building or a commercial facility, not a dwelling house, the building may also be a dwelling house such as a multi-family dwelling house or a single-family dwelling house. Alternatively, the building may also serve as any of various other types of facilities including schools, supermarkets, convenience stores, athletic facilities, hotels, art museums, museums, hospitals, warehouses, and factories. Furthermore, even if the building is a piece of architecture not falling within the category of normal buildings (i.e., with no roofs, pillars, or walls), such as a road or a bridge, the technology to be described below is also applicable to such a building. Moreover, the building does not have to be the entire piece of architecture but may also be only a partial piece of architecture such as a dwelling unit, or even a room, of a multi-family dwelling house.

As used herein, the equipment, for which control data is created, refers to a piece of equipment having its operation controlled by a controller to be described later. Examples of such pieces of equipment include lighting equipment, air conditioning equipment, blinds, shutters, disaster prevention equipment, crime prevention equipment, water supply equipment, drainage equipment, elevators, escalators, and refrigeration equipment (including refrigerators and freezers), and may include audiovisual equipment as well.

Meanwhile, the controller herein falls under the categories of a central monitoring device for use in a building management system, a controller for an energy management system, and a master device for use in a remote control monitoring system, for example. The energy management system herein refers to a BEMS, an MEMS, or a HEMS (home energy management system). In Japan, BEMS stands for a building energy management system, and MEMS stands for a mansion energy management system.

The remote control monitoring system is mainly used for controlling lighting equipment including a large number of lighting fixtures. In the following embodiments, the controller will be used as a master device for a remote control monitoring system as an example.

The controller is configured to store the control data and control the equipment's operation in accordance with the control data. The information creation device does not have to create control data for every piece of equipment installed in the building, but may create the control data for only any single piece of equipment. Meanwhile, if there are multiple controllers in the building, the information creation device may create control data for each of those controllers.

In the following embodiments, architectural design, structural design, and equipment design processes are supposed to have been finished for a building, and BIM data about the architectural design, structure, equipment and other properties of the building is supposed to have been created. The BIM data about the structure of the building includes attribute information such as the names, shapes, dimensions, arrangement, specifications, manufacturers' names, and product numbers of constituent members of the building. In this case, the shape of a member herein refers to the three-dimensional shape thereof, and the arrangement of members herein refers to information about locations where the members in question are used in the building. The BIM data about the equipment of the building further includes attribute information such as the names, types, arrangement, specifications, manufacturers' names, and product numbers of devices that form the equipment for use in the building. As used herein, the arrangement of the equipment herein refers to information about the locations where the devices forming the equipment in the building are installed.

In general, devices that form equipment include first devices performing an intended function, for which the equipment is used, and second devices configured to control the state of the first devices. In the case of lighting equipment, for example, the first devices may include lighting fixtures, and the second devices may include switches or sensors, for example. In the case of air conditioning equipment, the first devices may include indoor and outdoor units, and the second devices may include switches instructing those units to start or stop operating and a controller defining a temperature setting. Likewise, any other type of equipment also includes first devices and second devices.

In the following embodiments, the building is supposed to be an office building, and the equipment is supposed to be lighting equipment, for example. The lighting equipment is comprised of a plurality of (e.g., 100 or more) lighting fixtures installed in the office building and a remote control monitoring system for remotely monitoring and controlling the lighting states of those lighting fixtures by communications technology.

The remote control monitoring system includes a plurality of terminal devices, each of which is connected to any of switches, sensors, or lighting fixtures, and a master device for controlling the state of at least one lighting fixture through the terminal device(s). A terminal device connected to a switch or a sensor receives, from the switch or the sensor, information instructing that the lighting states of the lighting fixtures be changed. A terminal device connected to a lighting fixture may be configured to either control the ON and OFF states of the lighting fixture or control at least one of the light output or the luminous color of the lighting fixture. Examples of the sensors include a brightness sensor for monitoring the brightness of a surrounding environment, a human sensor for detecting the presence of any human in a predetermined spatial region, and a temperature sensor for monitoring the temperature of the surrounding environment. The terminal devices include first terminal devices for receiving, from the switches or the sensors, information instructing that the lighting states of the lighting fixtures be changed and second terminal devices for controlling the lighting states of the lighting fixtures by giving instructions to them.

Optionally, each terminal device may be integrated with at least one of lighting fixtures, switches, or sensors.

In this embodiment, the lighting equipment is comprised of devices such as lighting fixtures, switches, sensors, a master device, and terminal devices. In addition, the lighting equipment is accompanied with a line for supplying power to the lighting fixtures, a communications line for connecting the master device to the terminal devices, and other lines or cables.

Every terminal device is connected to, and communicates with, the master device through a communications line. The master device is configured to acquire information received at a first terminal device and give a second terminal device an instruction to control the lighting state of a lighting fixture in accordance with the information acquired.

This remote control monitoring system is supposed to include a plurality of switches or sensors and a plurality of lighting fixtures. The association between switches or sensors and lighting fixtures is stored by the master device. That is to say, the master device manages the correspondence between each switch or sensor and its associated lighting fixture and also manages the contents of the instruction to be given to the lighting fixture in accordance with the information acquired from the switch or the sensor. For example, the master device stores their association indicating what switch needs to be operated to turn ON or OFF the lighting fixture. The master device also stores their operational relationship indicating what to do with the lighting state of the lighting fixture in what state detected by the sensor.

In this remote control monitoring system, identification information is set to distinguish a plurality of switches or sensors from each other and to distinguish a plurality of lighting fixtures from each other. The identification information is actually assigned to terminal devices. The master device manages the correspondence between the switches or sensors and the lighting fixtures based on the identification information. That is to say, the master device may not only establish correspondence between each switch or sensor and a lighting fixture one to one but also between each switch or sensor and a plurality of lighting fixtures one to multiple. In the latter case, a single switch or sensor is able to control a plurality of lighting fixtures collectively. Such control of establishing correspondence between each switch or sensor and a plurality of lighting fixtures one to multiple as opposed to the individual control of establishing correspondence between each switch or sensor and a lighting fixture one to one will be hereinafter referred to as “collective control.” For example, storing, in the master device, control data to associate the identification information for a plurality of lighting fixtures with the identification information for a single switch allows the single switch to change the lighting states of the plurality of lighting fixtures collectively. There are multiple types of collective control, namely, group control and pattern control (scene control).

The group control is performed by storing, in the master device, control data so as to associate the identification information for a single switch with the identification information for a plurality of lighting fixtures. That is to say, according to the group control, operating a single switch allows a plurality of lighting fixtures, designated by the control data, to turn into the same lighting state collectively. Thus, the group control enables a plurality of lighting fixtures to be turned ON or OFF at a time by operating a single switch.

The pattern control is performed by storing, in the master device, control data so as to associate the identification information for a single switch with the identification information for a plurality of lighting fixtures and their respective lighting states. That is to say, according to the pattern control, operating a single switch enables collective control for turning a plurality of lighting fixtures, designated by the control data, into the respective lighting states defined by the control data. Thus, the pattern control enables some of the lighting fixtures to turn ON, and the other lighting fixtures to turn OFF, by operating a single switch. If the lighting fixtures have at least one of the function of controlling the light output (hereinafter referred to as “light output control function”) or the function of controlling the luminous color (hereinafter referred to as “light color control function”), then at least one of the light output or the luminous color may be added to the control data, no matter whether the type of control to perform is the group control or the pattern control.

The foregoing description of the pattern control and group control is also applicable even if the switches are replaced with sensors. A technology for this type of remote control monitoring system is well known in the art and the configuration of the remote control monitoring system does not constitute a major feature thereof, and detailed description thereof will be omitted herein.

As can be seen from the foregoing description, the control data includes association information containing pieces of identification information individually set for respective lighting fixtures and switches and state information indicating respective states of the lighting fixtures and switches. Each of the pieces of identification information is associated with at least another one of the pieces of identification information. That is to say, the control data is created so as to associate the state of a particular switch with the lighting state of particular lighting fixture(s).

Adopting the remote control monitoring system described above in an office building will require doing the jobs of determining the arrangement of lighting fixtures, selecting lighting fixtures to be subjected to either the group control or the pattern control, and determining the ON and OFF states of the lighting fixtures. In addition, the job of determining the light outputs or luminous colors of the respective lighting fixtures also needs to be done depending on the necessity. Once the arrangement of the lighting fixtures has been determined in this manner, the arrangement of switches, sensors, or any other type of devices to be associated with the lighting fixtures needs to be determined, and instruction information defining the association between the pieces of identification information for the switches, sensors, or any other type of devices and the lighting fixtures and the states of the lighting fixtures needs to be stored as control data in the master device. That is to say, control data for associating the switches, sensors, or any other type of devices with the lighting fixtures needs to be designed. In this embodiment, the instruction information defining the state of a lighting fixture is a piece of information instructing what state or level (such as the ON or OFF state, the light output, or the luminous color) the lighting fixture should assume when the switch is operated or when the sensor reacts.

These jobs are carried out by either the designer or the contractor with their knowledge from experience applied. Nevertheless, such jobs will heavily depend on those person's skills, and therefore, the outcome will not always be as intended by the designer or the contractor and will not always be fully satisfactory for the owner, either. In addition, the control data is set on the spot in accordance with the specific data that has been designed in advance on the desk, thus imposing a heavier workload on workers on the spot when storing the control data in the master device. Furthermore, before the building actually starts to be constructed, the control data is designed for no physical entity. That is why controlling the lighting equipment in accordance with the control data stored in the master device after the building has actually started to be constructed may sometimes produce an end result contrary to the planner's or owner's intention. In such a situation, the control data could not recover its effectiveness even when subjected to minor modifications on the spot and could have to be created from the beginning all over again.

The following embodiment allows control data that will be stored in the master device to be created based on the building model data designed by the modeling device, even when there is no physical entity yet, thus reducing the workload when the control data is created. In addition, the embodiment to be described below allows the control data created to be stored as it is in the master device, thus reducing the workload on the spot for the master device. Furthermore, the embodiment to be described below also allows the control data created to be verified before the control data is stored in the master device, and therefore, contributes to reducing the risk of producing an unintended result when the control data created is stored in the master device.

### Embodiments

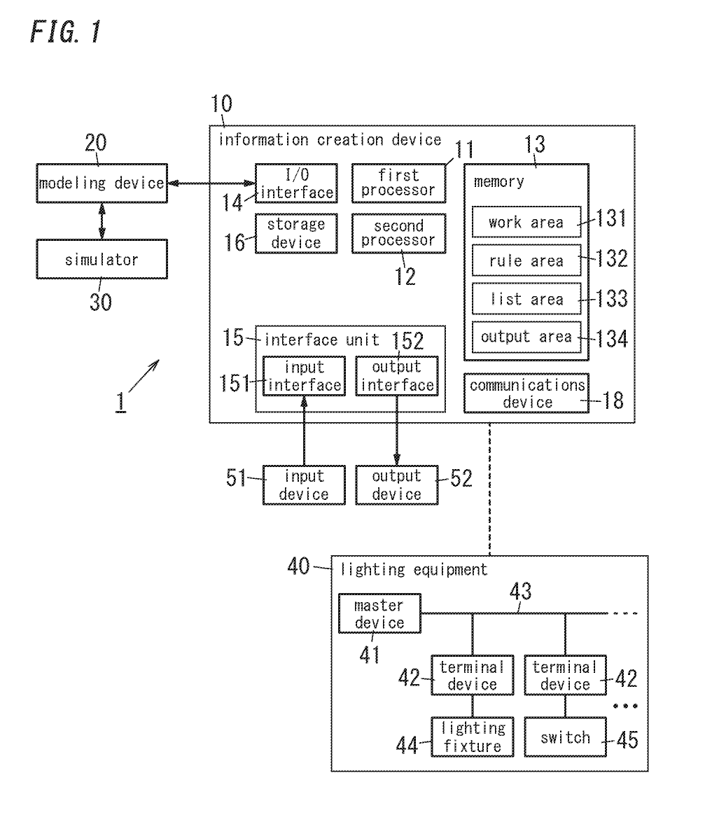

An exemplary embodiment will be described as being applied to the information creation system 1 shown in FIG. 1 as an example. The information creation system 1 shown in FIG. 1 includes an information creation device 10, a modeling device 20, and a simulator 30. The information creation device 10 is a device for creating control data. The modeling device 20 is a device for creating BIM data.

The lighting equipment 40 for use in this embodiment includes a single master device 41, a plurality of terminal devices 42, at least one lighting fixture 44, and at least one switch 45. The master device 41 and the terminal devices 42 are connected together through a communications line 43. Each of the terminal devices 42 is connected to either the lighting fixture 44 or the switch 45. In FIG. 1, either a single lighting fixture 44 or a single switch 45 is connected to each terminal device 42. According to an alternative configuration, either a plurality of lighting fixtures 44 or a plurality of switches 45 may be connected to each single terminal device 42. Furthermore, although only one lighting fixture 44 and only one switch 45 are shown in FIG. 1, normally a plurality of lighting fixtures 44 and a plurality of switches 45 are provided. Alternatively, the switch 45 may also be replaced with a sensor. In the following description, the switches 45 and sensors will be collectively hereinafter referred to as “switches 45” unless there is any need to distinguish one from the other.

In the lighting equipment 40, the master device 41 and the terminal devices 42 are provided to associate the state of the lighting fixture 44 with the state of the switch 45 by communications technology. Specifically, the master device 41 monitors the state of the switch 45 via one of the terminal devices 42, creates instruction information determining the state of the lighting fixture 44 in accordance with monitoring information indicating the state of the switch 45, and instructs, via another one of the terminal devices 42, the lighting fixture 44 what state the lighting fixture 44 should assume. Thus, the state of the lighting fixture 44 is controlled in accordance with the state of the switch 45. In other words, the master device 41 and the terminal devices 42 play the role of conveying information to have the state of the switch 45 reflected on the state of the lighting fixture 44.

In this case, the user of the lighting equipment 40 does not have to be conscious of the existence of the master device 41 and the terminal devices 42 but just needs to recognize the correspondence between the switch 45 and the lighting fixture 44. In other words, for the user, only the lighting fixture 44 and the switch 45 form the lighting equipment 40. That is to say, the user is able to handle this lighting equipment 40 as long as he or she recognizes the arrangement of the first device (i.e., the lighting fixture 44) and the second device (i.e., the switch 45) that form the lighting equipment 40 and the state of the lighting fixture 44 that changes in accordance with the state of the switch 45.

In this embodiment, the simulator 30 is used to verify the control data. The simulator 30 is able to make simulation of at least the operation of the lighting equipment 40. The simulator 30 is configured to allow the user to visually check the illumination state of the space where the lighting fixture is installed on the screen of the output device (monitor device) 52 according to the lighting state of the lighting fixture 44 in accordance with information about the architecture of the building included in the BIM data.

As described above, the lighting states of the lighting fixture 44 include not only the ON and OFF states but also light output information if the lighting fixture 44 is able to be dimmed and color information if the lighting fixture 44 is able to have its luminous color controlled. Also, the illumination state of the lighting fixture 44 includes information about the illumination distribution in the space where the lighting fixture 44 is arranged, and may include information about the color distribution of the virtual space where the lighting fixture 44 is arranged if the lighting fixture 44 is able to have its luminous color controlled.

In response to the BIM data and the control data for the lighting fixture 44 provided, the simulator 30 displays the space represented by the BIM data on the screen of the output device 52 and renders the lighting and illumination states of the lighting fixture 44 on the screen of the output device 52 in accordance with the control data. That is to say, the user is allowed to visually check the lighting and illumination states of the lighting fixture 44 in its corresponding space through the screen of the output device 52. The user is allowed to change the viewpoint, from which he or she is looking at the space to be displayed on the screen of the output device 52, and the lighting state of the lighting fixture 44 by operating the input device 51.

If the user is not satisfied with the result of the simulation made by the simulator 30, he or she may modify the control data by operating the information creation device 10. That is to say, the information creation device 10 accepts an instruction to modify the control data from the input device 51 and updates the contents of the control data. Then, the information creation device 10 has simulation made again by the simulator 30.

The simulator 30 is suitably able to simulate both a lighting environment in a situation where artificial light emitted from the lighting equipment 40 is used and a lighting environment in a situation where external light is used in combination with the artificial light emitted from the lighting equipment 40. Also, although the simulator 30 is configured in this embodiment to simulate the lighting environment with respect to the space where the lighting equipment 40 is arranged, the simulator 30 is suitably configured to simulate not only such a lighting environment but also any other environment flexibly according to the type of the given equipment.

In the exemplary configuration shown in FIG. 1, the information creation device 10, the modeling device 20, and the simulator 30 are implemented as respectively independent devices (i.e., computers) for convenience sake in order to indicate the difference in their role to play. Actually, however, any arbitrary number of computers may function as these devices. For example, a single computer may function as all of the information creation device 10, the modeling device 20, and the simulator 30. Alternatively, the modeling device 20 may be comprised of a plurality of computers. As a program performing the function of the modeling device 20 is executable by a server, programs performing the functions of the information creation device 10 and the simulator 30 are also executable by the server. According to this configuration, as long as the user has a terminal device communicating with the server, he or she may use not only the modeling device 20 but also the information creation device 10 and the simulator 30 as well.

The information creation device 10 is implemented by making a computer execute a program in order to perform the function to be described below. The information creation device 10 is configured to receive BIM data from the modeling device 20 and deliver control data to the master device 41 of the lighting equipment 40 in the real space. The BIM data that the information creation device 10 of this embodiment receives from the modeling device 20 is data for which equipment design has already been done and includes data about the type, arrangement, and specifications about the devices that form the lighting equipment 40.

The modeling device 20 and the information creation device 10 are configured to exchange data such as the BIM data bidirectionally between them through communication. The information creation device 10 and the master device 41 are also configured to exchange the control data bidirectionally between them through communication. Alternatively, the modeling device 20 and the information creation device 10 may also be configured to exchange data between them through a storage medium such as a memory card, instead of through communication. Likewise, the information creation device 10 and the master device 41 may also be configured to exchange the control data between them through a storage medium, instead of through communication.

To the information creation device 10, connected are an input device 51 for giving instructions to the information creation device 10 and an output device 52 for displaying information such as the control data created by the information creation device 10. The output device 52 may also display control data being created. The input device 51 is generally implemented as a combination of a keyboard and a mouse. Alternatively, the mouse may be replaced with a touch pad, a pen tablet, a touchscreen panel, or any other device. Also, the output device 52 is supposed to be a monitor device with a liquid crystal display in this embodiment, but may also be an organic light-emitting diode (OLED) display, a cathode ray tube (CRT), or any other suitable type of display device. The output device 52 suitably includes a printer in addition to the monitor device. If the information creation device 10 is implemented as a server, then the input device 51 and the output device 52 will be connected to the information creation device 10 via a terminal device.

The information creation device 10 allows the user to perform an interactive input operation through the input device 51 and the output device 52. That is to say, in accordance with the information displayed on the output device 52 (monitor device) of the information creation device 10, the user may give instructions to the information creation device 10 using the input device 51.

Note that an input device and an output device are also suitably connected to each of the modeling device 20 and the simulator 30, as well as the information creation device 10. Alternatively, the input device 51 and output device 52 connected to the information creation device 10 may also function as the input device and output device for at least one of the modeling device 20 or the simulator 30. Among other things, the input device and output device connected to the simulator 30 suitably also function as the input device 51 and output device 52 connected to the information creation device 10. Making the information creation device 10 and the simulator 30 share the input device 51 and the output device 52 allows the user to check results of simulations on the output device 52 and to modify the control data with the input device 51 while verifying the control data with the simulator 30. That is to say, this allows the user to confirm the state of control based on the control data on the output device 52 and to modify the control data as needed with the input device 51, thus enabling the user to get his or her job done in a shorter time.

The information creation device 10 includes an input/output interface (hereinafter referred to as an “I/O interface”) 14 configured to send data to, and receive data from, the modeling device 20. In the exemplary configuration shown in FIG. 1, only the modeling device 20 is directly connected to the I/O interface 14, and the simulator 30 is configured to send data to, and receive data from, the information creation device 10 via the modeling device 20. Naturally, however, both the modeling device 20 and the simulator 30 may be connected to the I/O interface 14. Alternatively, the information creation device 10, the modeling device 20, and the simulator 30 may also be configured to exchange data between them over a telecommunications line such as a local area network (LAN) or the Internet.

The information creation device 10 includes an interface unit 15 to which the input device 51 and the output device 52 are connected. The interface unit 15 includes an input interface 151 to which the input device 51 is connected and an output interface 152 to which the output device 52 is connected.

The information creation device 10 includes a processing device (comprised of a first processor 11 and a second processor 12) and a memory 13. The information creation device 10 suitably further includes a storage device 16 such as a hard disk drive. As described above, the information creation device 10 of this embodiment receives, from the modeling device 20, the BIM data for which equipment design has already been done. The BIM data is data created by the designer of a building or any other person using the modeling device 20, and includes various kinds of data about the building. A work area 131 is a particular area provided for the address space of the memory 13 as an area for mainly storing the data to be processed.

A piece of hardware functioning as the information creation device 10 may be a computer, for example, and the components of the information creation device 10 are connected to a bus. All of the components of the information creation device 10 but the memory 13, the I/O interface 14, and the interface unit 15 may be implemented as a device including a processor executing a program. This type of device may be a central processing unit (CPU), for example, which forms a computer along with a memory and an interface device.

The first processor 11 has the capability of extracting only required data for creating control data from the BIM data received from the modeling device 20 via the I/O interface 14 and storing the required data in the work area 131. If the information creation device 10 and the modeling device 20 are implemented as two different computers as in this embodiment, the information creation device 10 suitably downloads the BIM data from the modeling device 20 and once stores the data in the storage device 16. Then, the first processor 11 suitably extracts required data for creating control data from the storage device 16. Meanwhile, if the information creation device 10 and the modeling device 20 share the same computer, then the first processor 11 suitably extracts the required data and stores it in the work area 131 while the information creation device 10 is receiving the BIM data from the modeling device 20.

In this case, the required data for creating the control data is data included in the BIM data and related to the equipment installed in the building. In this embodiment, the information creation device 10 is supposed to create control data for the lighting equipment 40, and therefore, only data about the lighting equipment 40 is needed to create the control data. In other words, to create the control data, data about the components that form the lighting environment, such as data about the lighting equipment 40 and data about building blocks of the lighting space, are required among the BIM data, and data representing the architectural design of the building, for example, is basically not required.

For these reasons, the first processor 11 is configured to extract only the data about the lighting equipment 40 from the BIM data and store it in the work area 131. That is to say, the first processor 11 sorts out only required data for creating the control data from the BIM data. In other words, the first processor 11 functions as a filter with respect to the BIM data.

In sorting out the required data from the BIM data, the first processor 11 pays attention to attribute information included in the BIM data. The attribute information is information about the names, arrangement, specifications, and other parameters of members and equipment that form the building. The first processor 11 extracts data for use to design the lighting environment from the BIM data based on at least the names and arrangement.

The first processor 11 uses a plurality of extraction rules to extract data about the lighting equipment 40 from the BIM data. Those extraction rules are defined such that when the user specifies, via the input device 51, the space to which control data is applied for the lighting equipment 40 (hereinafter referred to as a “target space”), data about the members and equipment arranged in the target space will be extracted. The extraction rules are stored in a rule area 132 of the memory 13. The target space is suitably specified hierarchically. For example, the target space is classified into buildings, floors, rooms, zones, and other units in multiple layers. The user specifies the target space by operating the input device 51 so as to appropriately specify these parameters.

The extraction rules are defined based on the attribute information. For example, some extraction rule may set the condition that the member should be exposed to the target space. Another extraction rule may set the condition that the lighting equipment 40 should include a lighting fixture 44 arranged in the target space. In this case, the member exposed to the target space and the lighting fixture 44 arranged in the target space may be determined in accordance with the attribute information included in the BIM data. That is to say, the list of names of the members and equipment to extract is stored in the list area 133 provided for the memory 13. The first processor 11 extracts a member or equipment, of which the name matches the one stored in the list area 133, into the target space.

For example, suppose a rule defining that required data for creating control data should be extracted under the condition that the target space is a room, the name “ceiling panel” is stored in the list area 133, and the member is exposed to the target space is stored in the rule area 132. Also, suppose an auxiliary rule of determining that the ceiling panel should be exposed to the target space under the condition that the ceiling panel is connected to the wall panels (i.e., the coordinates of the upper end of the wall panels and the coordinates of an end of the ceiling panel fall within a predetermined range) is also stored in the rule area 132.

In this case, the first processor 11 determines, by reference to the BIM data, whether or not there is a member with the name “ceiling panel” stored in the list area 133 within the target space specified by the user. Since the ceiling panel is supposed to exist in this example, the ceiling panel is extracted as a candidate. In this example, a determination is made whether or not the ceiling panel is connected to the wall panels in accordance with the auxiliary rule. If the ceiling panel is connected to the wall panels, then the decision is made that the ceiling panel is exposed to the target space. That is to say, the first processor 11 recognizes this ceiling panel as required data for creating the control data in accordance with the extraction rules and stores data about the ceiling panel in the work area 131.

Backing materials for a floor, a ceiling, and walls are ordinarily not exposed to the target space. However, if these members are registered with the list area 133 and are determined to be exposed to the target space in accordance with the auxiliary rule, then data about these materials is also determined to be required data for creating the control data in accordance with the extraction rules.

As described above by way of illustrative examples, if components of a building included in the BIM data satisfy either the condition imposed by any rule or the condition imposed by a plurality of rules, then the first processor 11 stores data about those components in the work area 131. Also, although data about members is supposed to be extracted in the example described above, the same statement is also applicable to the equipment. This embodiment is supposed to be applied to the lighting equipment 40. Therefore, under the condition that the lighting fixture 44 is exposed to the target space specified, the first processor 11 extracts data about the lighting equipment 40 in question as data for use to create the control data.

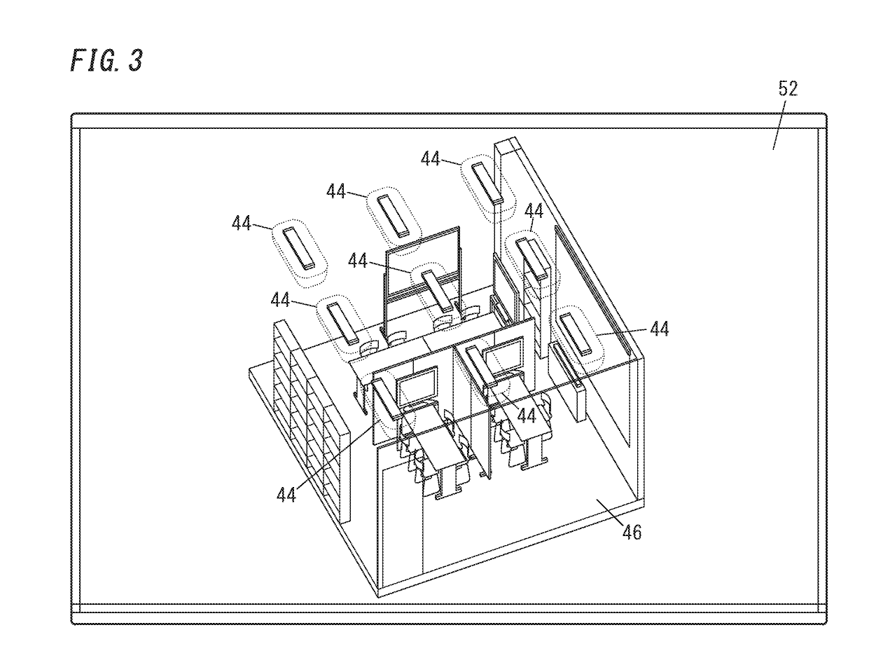

When the data used for creating the control data is stored in the work area 131, required information for creating the control data is displayed on the output device (monitor device) 52 connected to the information creation device 10. The display format may be selected from multiple different types by allowing the user to operate the input device 51. For example, according to one display format, the correspondence between the switches 45 and lighting fixtures 44 arranged in the target space may be displayed as a table. According to another display format, the relative arrangement between the switches 45 and the lighting fixtures 44 may be shown on a plan view of the target space. Using a perspective view of the target space as shown in FIG. 3, which is viewed through the ceiling, instead of the plan view, would allow the lighting fixtures 44 to be represented three-dimensionally in the target space 46 as virtual space built by the information creation device 10. Representing the arrangement as a perspective view would allow the user to grasp the arrangement of the lighting fixtures 44 in the target space 46 more easily. Also, it is recommended to not only represent the arrangement of the switches 45 and the lighting fixtures 44 in a plan view of the target space but also provide a display format showing how the lighting states of the lighting fixtures 44 change by operating the switches 45. Note that the lighting states of the lighting fixtures 44 may be represented in multiple different colors, for example.

The information creation device 10 may be further provided with a display format in which a change in the lighting states of the lighting fixtures 44 with the turn of the switches 45 is reflected in a three-dimensional image of the target space where the lighting fixtures 44 are arranged. Such a display format using a three-dimensional image allows the user to make shading, rendering, and other types of processing. This type of processing may be performed by the simulator 30. Since the information creation device 10 suitably has as short a read time as possible in creating the control data, even such a three-dimensional image may be used just for the purpose of checking the lighting states of the lighting fixtures 44.

When the first processor 11 stores the data extracted from the BIM data in the work area 131, the second processor 12 is allowed to create the control data. The second processor 12 displays information on the output device (monitor device) 52 in the display format described above, and accepts input data from the input device 51. The input data defines a condition for creating the control data, and also includes information to identify the lighting fixtures 44 and the switches 45. The condition for creating the control data is a condition defining what lighting fixtures 44 are associated with what switches 45 and what lighting states the lighting fixtures 44 should have in response to what states of the switches 45. Thus, the second processor 12 receives, from the input data, the contents of association information that associates each of pieces of identification information of the switches 45 with at least one of pieces of identification information of the lighting fixtures 44 and the contents of state information indicating the lighting states of the lighting fixtures 44 and the states of the switches 45.

The second processor 12 creates the control data based on the data extracted by the first processor 11 and the input data received from the input device 51. The control data is stored in an output area 134 of the memory 13. Selecting a display format that allows the user to check the lighting states of the lighting fixtures 44 enables him or her to visually check the contents of the control data stored in the output area 134. Also, a skilled user could determine, even in the format of a table or a plan view, whether the control data is appropriate or not.

The control data stored in the output area 134 is passed to the master device 41 of the lighting equipment 40 via the communications device 18 of the information creation device 10. Alternatively, as described above, the control data may also be passed from the information creation device 10 to the master device 41 via a storage medium such as a memory card.

In this embodiment, the control data to be stored in the master device 41 of the remote control monitoring system is supposed to be created with the information creation device 10. Thus, the control data includes pieces of identification information of the switches 45 and the lighting fixtures 44 and pieces of information to establish correspondence between the identification information of the switches 45 and that of the lighting fixtures 44. The correspondence between the identification information of the switches 45 and that of the lighting fixtures 44 includes not only one-to-one correspondence but also one-to-multiple correspondence such as pattern control (scene control) and group control. The control data may also include information indicating how the lighting states of the lighting fixtures 44 change according to the time period and information indicating how the lighting states of the lighting fixtures 44 change according to the event to be monitored by the sensor. Providing such information indicating how the lighting states of the lighting fixtures 44 change according to the time period allows the lighting fixtures 44 to change their lighting states according to the time period in which the switches 45 are operated.

The control data includes: state information indicating the respective states of the lighting fixtures 44 and switches 45 as devices that form the lighting equipment 40; and association information that associates each of the pieces of identification information individually set for the respective switches 45 with at least one of the pieces of identification information individually set for the lighting fixtures 44. That is to say, the lighting states of the lighting fixtures 44 and the states of the switches 45 are associated with each other via the association information indicating the association between the lighting fixtures 44 and the switches 45. Defining the state information and the association information in advance will make a lighting fixture 44, associated with a switch 45 operated via the association information, assume a lighting state corresponding to the state of the switch 45 in accordance with the state information.

Such contents of the control data are only an example. It is the user to decide what control data to create. The control data is created by the information creation device 10 in accordance with the creation condition defined by the input data. As described above, the input data includes contents of the association information that associates the switches 45 with the lighting fixtures 44 and contents of the state information of the lighting fixtures 44 and switches 45 that are associated with each other via the association information.

The BIM data includes information about the locations of the lighting fixtures 44 and switches 45 in the virtual space but does not include identification information of the lighting fixtures 44 and the switches 45. That is why to allow the information creation device 10 to create the control data in the virtual space, identification information needs to be set uniquely at least in the virtual space in association with the respective locations of the lighting fixtures 44 and the switches 45.

In setting the identification information for the lighting fixtures 44 and the switches 45 in the virtual space, the second processor 12 of the information creation device 10 displays the locations of the lighting fixtures 44 and the switches 45 on the output device (monitor device) 52 so as to allow the user to find their relative locations in the virtual space. In this case, the second processor 12 is ready to accept input data from the input device 51.

The information creation device 10 adopts at least one of a configuration allowing the user to set the identification information or a configuration to automatically set the identification information. According to the former configuration, when the second processor 12 is ready to accept the input data, the input data specifies the lighting fixtures 44 and the switches 45 on an individual basis, thus setting arbitrary identification information for the lighting fixtures 44 or switches 45 specified. On the other hand, according to the latter configuration, the initial value of the identification information, information to specify the lighting fixtures 44 and switches 45 for which the initial value of the identification information is set, and information about the order in which the identification information is set are given as input data to the second processor 12. That is to say, according to the latter configuration, the identification information is set in order such that the initial value of the identification information is set for the lighting fixtures 44 or switches 45 specified and that different pieces of identification information are set for the lighting fixtures 44 and switches 45.

A specific example will be described below. For example, in creating control data for performing group control, the second processor 12 selects lighting fixtures 44 and a switch 45 to be subjected to the group control in accordance with a creation condition defined by given input data. That is to say, to create association information among the control data, a switch 45 is selected and a plurality of lighting fixtures 44 to be associated with this switch 45 are selected. In addition, the second processor 12 defines the state of the switch 45 and the lighting state of the lighting fixtures 44 in accordance with the creation condition defined by the input data. In other words, to define state information among the control data, the lighting state of the lighting fixtures 44 and the state of the switch 45 are defined.

In selecting each of the plurality of lighting fixtures 44 to be associated with the switch 45, with a perspective view of the target space seen through the ceiling (see FIG. 3) displayed on the screen of the output device (monitor device) 52, for example, the second processor 12 has the figure of the lighting fixture 44 selected on the screen. In this case, the switch 45 has already been selected. Performing an operation corresponding to clicking a mouse with a cursor placed on the figure of the lighting fixture 44 to select gives the input data to the second processor 12.

Also, while the same screen is being displayed on the output device (monitor device) 52, the second processor 12 receives input data defining the lighting state of the lighting fixture 44 selected, and associates the lighting state with the state of the switch 45. In general, one lighting state (e.g., the ON state) of a lighting fixture 44 selected is associated with one state (representing, e.g., the ON state) of a switch 45. Alternatively, the other lighting state (the OFF state) of the lighting fixture 44 may be associated with the ON state of the switch 45.

If the lighting fixture 44 is controlled in accordance with at least one of the light output control or the slight color control, then the second processor 12 may regard at least one of the light output or luminescent color of the lighting fixture 44 as representing the lighting state and associate it with the state of the switch 45 as indicated by the input data. If a lighting fixture 44 with the ability to control at least one of the light output or the luminescent color is adopted, then the switch 45 associated with the lighting fixture(s) 44 is generally configured to include an operating section for controlling at least one of the light output or the luminescent color.

The above statement about a situation where control data for group control is created is also applicable to a situation where control data for pattern control is created. During creation of control data for pattern control, when a plurality of lighting fixtures 44 to be associated with the given switch 45 are selected, the lighting state is defined for each of the lighting fixtures 44. That is to say, the condition for creating control data for pattern control is defined such that the respective lighting states of the plurality of lighting fixtures 44 selected can be associated with the state (namely, the ON state) of the switch 45.

The information creation device 10 has the ability to create not only the control data for group control and the control data for pattern control described above but also control data for individual control as well. Furthermore, associating a plurality of switches 45 with a plurality of particular lighting fixtures 44 also allows control data to be created such that the lighting states of the particular lighting fixtures 44 are changed by those switches 45 arranged at multiple different positions. Alternatively, the switch 45 may also be a time switch, of which the ON and OFF states are automatically selected according to the time period. Still alternatively, instead of the switch 45, a sensor may be associated with the lighting fixture 44.

As can be seen from the example described above, the input data assigns identification information in the virtual space to each of the lighting fixtures 44 and switches 45. In addition, depending on the type of the control data that the user is going to create, the input data defines the contents of the association information that associates the switches 45 with the lighting fixtures 44 and the contents of the state information that associates the states of the switches 45 with the lighting states of the lighting fixtures 44. The second processor 12 of the information creation device 10 creates the contents of the state information and the association information under the creation condition defined by the input data.

In this embodiment, control data, including information about association between pieces of identification information of the switches 45 and lighting fixtures 44 created by the information creation device 10 in the virtual space, is stored in the master device 41. That is why the identification information of the switches 45 and lighting fixtures 44 in the real space needs to be associated with the identification information of the switches 45 and the lighting fixtures 44 in the virtual space. Furthermore, it is also necessary to perform the job of establishing the correspondence between the locations of the switches 45 and lighting fixtures 44 in the real space and the location information of the switches 45 and lighting fixtures 44 included in the BIM data. In storing the control data created by the information creation device 10 in the master device 41, it is necessary to perform the job of associating the identification information that has been set uniquely for the lighting fixtures 44 and switches 45 in the real space with the identification information set by the information creation device 10 in the virtual space. One to one correspondence needs to be established between the identification information in the virtual space and the identification information in the real space.

For example, the job of associating the identification information of the switches 45 and lighting fixtures 44 in the real space with the identification information of the switches 45 and lighting fixtures 44 in the virtual space may be performed manually on the spot with an identification information setter. This allows the location information in the virtual space according to the BIM data and the location information on the spot in the real space to be associated with each other.

Alternatively, a rule for providing identification information for the switches 45 and lighting fixtures 44 in the real space may be defined. In that case, applying the same rule to the virtual space handled by the information creation device 10 and the spot in the real space allows identification information to be assigned automatically to the switches 45 and lighting fixtures 44 in the real space so that one-to-one correspondence is established between each piece of the identification information assigned and an associated one of those switches 45 or lighting fixtures 44.

The rule for setting the identification information includes, as a condition, the relative positions of the lighting fixtures 44 and the switches 45 in the target space 46 and/or the form of connection between the lighting fixtures 44 and the switches 45. The form of connection between the lighting fixtures 44 and the switches 45 is actually the form of connection of the communications line between the master device 41 and the terminal devices 42 respectively corresponding to the lighting fixtures 44 and the switches 45.

As can be seen from the foregoing description, this information creation device 10 is configured to create the control data in the virtual space by using the BIM data and deliver the control data thus created to the master device 41. Thus, in storing the control data in the master device 41, there is no need to perform the job of registering the control data with the master device 41 arranged on the spot, thus reducing the workload on the spot. That is to say, in the real space, a heavy burden is placed on the worker on the spot because he or she has to move physically to get the work done. In contrast, using the information creation device 10 described above allows the labor to be lightened because the work is done in the virtual space. In addition, creating control data in the virtual space allows the user to correct any error of the control data in the virtual space. This also lightens the labor, compared to the work to get done in the real space.

When the information creation device 10 creates control data, interactive input is performed with the input device 51 and the output device 52, and a desired form of display on the output device 52 is selected, thereby allowing the user to check the lighting state of the lighting fixtures 44 in a situation where control data is applied. Nevertheless, with the information creation device 10 alone, it is difficult for the user to confirm, with a sense of reality, whether or not lighting is provided just as intended in a situation where control data is applied to the lighting equipment 40.

According to this embodiment, giving the control data to the simulator 30 allows the user to check the operation of the lighting equipment 40 in the virtual space. That is to say, the simulator 30 makes simulations based on the BIM data, and therefore, is allowed to simulate, with high fidelity in three-dimensional virtual space, how the lighting environment would be in the real space when the control data is applied. Consequently, this allows the user to verify, with approximately the same degree of accuracy achieved in the virtual space as in the real space, whether or not the control data created by the information creation device 10 lives up to the user's expectations.

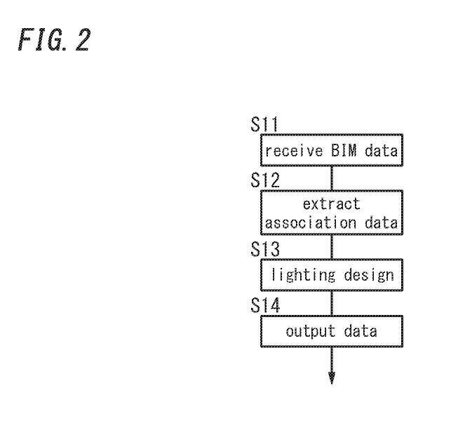

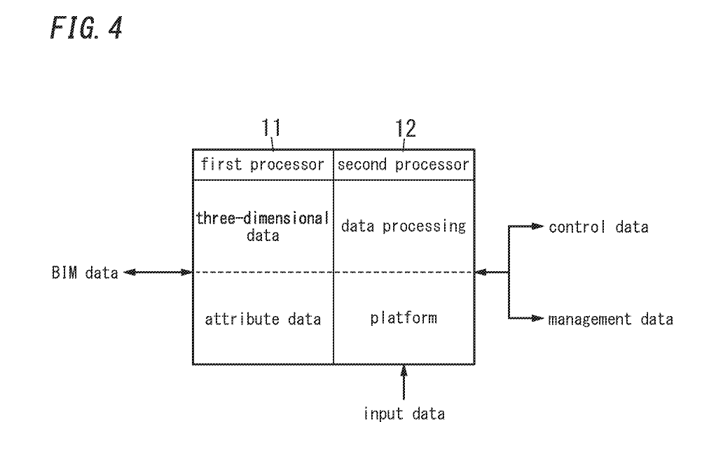

The procedure of creating control data with the information creation device 10 will be briefly summarized with reference to FIG. 2. The information creation device 10 receives BIM data from the modeling device 20 via the I/O interface 14 (in Step S11). The first processor 11 extracts data related to the equipment (e.g., the lighting equipment 40 in this embodiment) (in Step S12). That is to say, as schematically shown in FIG. 4, the first processor 11 extracts three-dimensional data and attribute data, which are needed in creating the control data, from the BIM data.

Next, based on the information about the lighting fixture 44 included in the data extracted from the BIM data, the second processor 12 makes lighting design interactively with the input device 51 and the output device 52 (in Step S13). The “lighting design” herein refers to defining the lighting states of the lighting fixtures 44 in the target space, and means receiving input data that has been input by the user via the input device 51. As used herein, the input data refers to data for use to perform group control, pattern control, light output control, light color control, and other types of control or adjustment. The input data specifies the condition for creating the control data with respect to the respective lighting fixtures 44. In the lighting design, control data is created for multiple different lighting states.

The control data may be created by the user from the beginning. Alternatively, the control data may also be created by having the information creation device 10 present a basic plan of control data to the user depending on the condition for the target space and by allowing the user to modify the basic plan. In the example illustrated in FIG. 4, the portion labeled “platform” means data to be presented as a basic plan to the user. The second processor 12 extracts the basic plan from the platform in accordance with the creation condition received as input data from the input device 51. If the second processor 12 has received input data corresponding to the control data from the input device 51, then the second processor 12 performs “data processing” on the input data. If the second processor 12 has extracted the basic plan, the second processor 12 performs “data processing” on the basic plan.

The information creation device 10 outputs the control data (in Step S14). The control data is data about group control, pattern control, light output control, light color control, and other types of control, and output to a storage medium such as a memory card. Also, as long as the master device 41 is connected to the information creation device 10, the information creation device 10 may deliver the control data to the master device 41. In that case, if the protocol used by the information creation device 10 is different from the protocol used by the master device 41, protocol conversion may be carried out by a protocol converter between the information creation device 10 and the master device 41. The control data created by the information creation device 10 may be integrated by the modeling device 20 with the BIM data. If the control data is integrated with the BIM data, the simulator 30 is allowed to make simulations on data including control data.

The information creation device 10 may not only give the control data to the lighting equipment 40 but also output control monitoring screen data (corresponding to the management data shown in FIG. 4) to display the operation of the lighting equipment 40 on the screen of the monitor device. The control monitoring screen data is created based on the BIM data and the control data. The control monitoring screen data may be configured such that the user is allowed to control, by looking at the arrangement of the lighting fixtures 44 and the switches 45 displayed on the screen of a display device, the lighting states of the lighting fixtures 44 and reflect the lighting states on the screen of the display device by operating the switches 45 on the screen.

The control monitoring screen data may be created in the Hyper Text Markup Language (HTML) format, for example, so as to run on a web browser. The control monitoring screen data includes content to display characters and figures on the screen and data representing buttons for accepting manipulations on the screen displayed. That is why in order to control and monitor the operation of the lighting equipment 40, a device to run a web browser is used, and the control monitoring screen data is passed to that device, thereby allowing the user to control and monitor the operation of the lighting equipment 40 on the screen of the device. This type of device may be selected from smartphones, tablet terminals, and other telecommunications devices. When a smartphone, a tablet terminal, or any other type of telecommunications device is used to control or monitor the lighting equipment 40, a dedicated application program (i.e., so-called “apps”) may be executed. In that case, the control monitoring screen data will be used as data when the dedicated application program makes a screen display, and the smartphone or tablet terminal will communicate with a master device of a remote control monitoring system.

As can be seen from the foregoing description, the information creation device 10 extracts only required data for creating control data from the BIM data, and creates the control data based on the data thus extracted, and therefore, the control data is smaller in size than the BIM data, thus reducing the processing load in creating the control data. This allows the information creation device 10 to use hardware resources of lower performance level. That is to say, the information creation device 10 does not have to use any special microprocessing unit (MPU) with exceptionally high processing performance or any memory with huge storage capacity. Thus, the information creation device 10 may be implemented as a personal computer comparable in performance to computers for use in offices or general consumers' houses.

As can be seen easily from the configuration described above, a program making a computer function as the information creation device 10 is configured to make the computer execute the steps of receiving BIM data and receiving input control data to determine equipment's operation. In the exemplary configuration described above, the first processor 11 extracts required data for creating the control data from the BIM data. If the information creation device 10 has sufficiently high processing performance, the BIM data may be used to create the control data without being processed.

In the embodiment described above, such a program making a computer execute the steps of receiving BIM data and receiving input control data to determine operation of equipment may be stored on a storage medium. In that case, the information creation device 10 (computer) performs the function by reading and executing the program stored on the storage medium.

(Variations)

A configuration in which the information creation device 10 also performs the function of the master device 41 of the lighting equipment 40 may be adopted. Particularly when a controller for controlling multiple types of equipment installed in a building is provided, the information creation device 10 may also perform the function of such a controller.

The information creation device 10 described above is provided independently of the modeling device 20 for creating BIM data. Alternatively, a single computer may function as both the modeling device 20 for creating the BIM data and the information creation device 10. In that case, a computer configured to execute an application program for creating the BIM data executes a program that makes the computer function as the information creation device 10, and therefore, control data may be integrated with the BIM data. That is to say, BIM data may be created by integrating the control data with normal BIM data. Integrating the control data with the BIM data may be carried out by the information creation device 10 with the above configuration. Even if the control data is integrated with the BIM data, the control data will be delivered, separately from the BIM data, to the controller (including the master device 41) for controlling the equipment of the building.

Also, as described above, the information creation device 10, the modeling device 20, and the simulator 30 may be built in a server. The server does not have to be configured as a single computer but may be comprised of a plurality of computers. Optionally, the server may be implemented as a cloud computing system as well.

The information creation system 1 may also be configured such that components of the information creation device 10 are distributed among multiple computers, instead of being integrated together in a single computer. The information creation system 1 may also be modified such that some or all of the components of the information creation device 10 shown in FIG. 1 form part of the modeling device 20 or the simulator 30. Alternatively, the information creation system 1 may also be configured to have no modeling device 20 and receive separately created BIM data.

As can be seen from the foregoing description, an information creation method according to a first aspect of the present invention includes the steps of receiving building model data (BIM data) and receiving input data in association with the building model data. The input data defines a condition for creating control data for controlling equipment (such as lighting equipment 40). In this method, the building model data includes information about architecture of a building and information about equipment of the building.

According to this embodiment, control data is created based on building model data and input data. In other words, an information creation method according to this embodiment includes the step of creating control data based on building model data and input data. Thus, this method allows control data for equipment to be created based on building model data.

The control data suitably includes association information configured to associate one of pieces of identification information, which have been set uniquely for a plurality of devices (e.g., lighting fixtures 44 and switches 45) that form the equipment (e.g., the lighting equipment 40), with at least another one of the pieces of identification information; and state information indicating respective states of the plurality of devices. The condition for creating as defined by the input data is suitably a condition for creating contents of the association information and contents of the state information.

An information creation method according to a second aspect of the present invention is an embodiment of the first aspect. In the second aspect, the step of creating suitably includes the following steps. Specifically, the information creation method further includes the steps of: setting the identification information for the plurality of devices in virtual space comprised of the building model data; and creating the contents of the association information and the contents of the state information in accordance with the condition for creating the control data. This method allows the control data be created in virtual space comprised of the building model data.

An information creation method according to a third aspect of the present invention is an embodiment of the second aspect. In the third aspect, the condition for creating the control data suitably defines the contents of the association information and the contents of the state information. The association information contains the pieces of identification information individually set for the plurality of devices in the virtual space comprised of the building model data. Each of the pieces of identification information is associated with at least another one of the pieces of identification information. The state information indicates the respective states of the plurality of devices. This method associates a plurality of devices with each other via the identification information and defines respective states of those devices as control data. Thus, the control data is created such that the state of a particular device (such as the switch 45) selected from the group consisting of a plurality of devices is associated with that of another particular device (such as the lighting fixture 44) selected from the group consisting of those devices.

An information creation method according to a fourth aspect of the present invention is an embodiment of any one of the first to third aspects described above, and suitably further includes the step of simulating operation of the equipment (such as the lighting equipment 40) based on the control data in the virtual space comprised of the building model data (BIM data). This information creation method has the simulation done in the virtual space with the control data created, thus enabling the control data created to be verified.

An information creation method according to a fifth aspect of the present invention is an embodiment of any one of the first to fourth aspects described above, and suitably further includes the step of storing the control data in a controller (such as a master device 41) configured to control equipment (such as the lighting equipment 40) in real space. This information creation method allows equipment (such as the lighting equipment 40) to be controlled based on the control data created.

An information creation method according to a sixth aspect of the present invention is an embodiment of any one of the first to fourth aspects described above, and suitably further includes the step of outputting a control signal based on the control data to equipment (such as the lighting equipment 40) in real space. This information creation method allows equipment (such as the lighting equipment 40) to be controlled based on the control data created.

An information creation method according to a seventh aspect of the present invention is an embodiment of any one of the first to sixth aspects described above, and suitably further includes the steps of accepting an instruction to modify the condition for creating the control data; and updating the control data responsive to receipt of the instruction to modify the condition. This information creation method allows the user to modify the control data.

An information creation method according to an eighth aspect of the present invention is an embodiment of any one of the first to seventh aspects described above, and suitably further includes the step of generating control monitoring screen data in order to display a screen configured to control and monitor operation of the equipment based on the building model data and the control data.

This information creation method allows not only control data for the equipment (such as the lighting equipment 40) but also control monitoring screen data to display a screen for remotely controlling and monitoring the equipment to be created, thus contributing to power saving during the installation of the equipment.

A storage medium according to a ninth aspect of the present invention has stored thereon a program configured to make a computer execute the steps of: receiving building model data (BIM data) including information about architecture of a building and information about equipment (such as the lighting equipment 40) of the building; and receiving input data in association with the building model data. The input data defines a condition for creating control data for controlling the equipment. The information creation device 10 is implemented by making a computer execute this program.

Such a program stored on a storage medium allows control data for equipment to be created based on the building model data.

An information creation device 10 according to a tenth aspect of the present invention includes an input/output interface 14, an input interface 151, a processing device (including a first processor 11 and a second processor 12), and an output interface 152. The input/output interface 14 is configured to receive building model data (BIM data) including information about architecture of a building and information about equipment (such as the lighting equipment 40) of the building. The input interface 151 is configured to receive input data in association with the building model data. The input data defines a condition for creating control data for controlling the equipment. The processing device is configured to create the control data based on the building model data and the input data. The output interface 152 is configured to output the control data created by the processing device.

This configuration allows control data for the equipment to be created based on the building model data and also allows the equipment to be controlled based on the control data thus created.

An information creation device 10 according to an eleventh aspect of the present invention is an embodiment of the tenth aspect. In the eleventh aspect, the processing device (including a first processor 11 and a second processor 12) suitably has the following function. Specifically, the processing device is suitably configured to set the identification information for the plurality of devices (such as the lighting fixtures 44 and the switches 45) in virtual space comprised of the building model data, and create the contents of the association information and the contents of the state information in accordance with the condition for creating the control data. This configuration allows control data to be created in virtual space comprised of the building model data.

An information creation system 1 according to a twelfth aspect of the present invention includes an input/output interface 14, an input interface 151, a processing device (including a first processor 11 and a second processor 12), and an output interface 152. The input/output interface 14 is configured to receive building model data (BIM data) including information about architecture of a building and information about equipment (such as the lighting equipment 40) of the building. The input interface 151 is configured to receive input data in association with the building model data. The input data defines a condition for creating control data for controlling the equipment. The processing device is configured to create the control data based on the building model data and the input data. The output interface 152 is configured to output the control data created by the processing device.

This configuration allows control data for the equipment to be created based on the building model data and also allows the equipment to be controlled with the control data thus created.

An information creation system 1 according to a thirteenth aspect of the present invention is an embodiment of the twelfth aspect. In the thirteenth aspect, the processing device (including a first processor 11 and a second processor 12) suitably has the following function. Specifically, the processing device is suitably configured to set the identification information for the plurality of devices (such as the lighting fixtures 44 and the switches 45) in virtual space comprised of the building model data, and create the contents of the association information and the contents of the state information in accordance with the condition for creating the control data. This configuration allows control data to be created in virtual space comprised of the building model data.

An information creation system 1 according to a fourteenth aspect of the present invention includes the information creation device 10 described above; and a simulator 30 configured to simulate operation of the equipment based on the control data in virtual space built by a computer. This configuration allows the control data created by the information creation device 10 to be verified.

A program according to a fifteenth aspect of the present invention makes a computer execute the steps of receiving building model data (BIM data) and receiving input data in association with the building model data. The input data defines a condition for creating control data for controlling equipment. In this program, the building model data includes information about architecture of a building and information about equipment (such as the lighting equipment 40) of the building. This program allows control data for controlling the equipment to be created based on the building model data.

Although the present invention has been described with reference to exemplary embodiments, those embodiments should not be construed as limiting but numerous modifications or variations can be readily made by those skilled in the art depending on their design choice or any other factor without departing from the true spirit and scope of the invention as defined by the appended claims.

### REFERENCE SIGNS LIST

1 Information Creation System
10 Information Creation Device
11 First Processor (Processing Device)
12 Second Processor (Processing Device)
14 Input/Output Interface
20 Modeling Device
30 Simulator
40 Lighting Equipment (Equipment)
44 Lighting Fixture
45 Switch
151 Input interface
152 Output interface

1. An information creation method comprising the steps of:
receiving building model data including information about architecture of a building and information about equipment of the building; and
receiving input data in association with the building model data, the input data defining a condition for creating control data for controlling the equipment.

2. The information creation method of claim 1, wherein
the control data includes:
association information configured to associate one of pieces of identification information, which have been set uniquely for a plurality of devices that form the equipment, with at least another one of the pieces of identification information; and
state information indicating respective states of the plurality of devices,
the condition for creating as defined by the input data is a condition for creating contents of the association information and contents of the state information, and
the information creation method further comprises the steps of:
setting the identification information for the plurality of devices in virtual space comprised of the building model data; and
creating the contents of the association information and the contents of the state information in accordance with the condition for creating the control data.

3. The information creation method of claim 2, wherein
the condition for creating the control data defines
the contents of the association information containing the pieces of identification information individually set for the plurality of devices in the virtual space comprised of the building model data, each of the pieces of identification information being associated with at least another one of the pieces of identification information; and
the contents of the state information indicating the respective states of the plurality of devices.

4. The information creation method of claim 1, further comprising the step of
simulating operation of the equipment based on the control data in the virtual space comprised of the building model data.

5. The information creation method of claim 1, further comprising the step of
storing the control data in a controller configured to control equipment in real space.

6. The information creation method of claim 1, further comprising the step of
outputting a control signal based on the control data to equipment in real space.

7. The information creation method of claim 1, further comprising the step of
accepting an instruction to modify the condition for creating the control data; and
updating the control data responsive to receipt of the instruction to modify the condition.

8. The information creation method of claim 1, further comprising the step of
generating control monitoring screen data in order to display a screen configured to control and monitor operation of the equipment based on the building model data and the control data.

9. A storage medium having stored thereon a program configured to make a computer execute the steps of:
receiving building model data including information about architecture of a building and information about equipment of the building; and
receiving input data in association with the building model data, the input data defining a condition for creating control data for controlling the equipment.

10. An information creation device comprising:
an input/output (I/O) interface configured to receive building model data including information about architecture of a building and information about equipment of the building;
an input interface configured to receive input data in association with the building model data, the input data defining a condition for creating control data for controlling the equipment;
a processing device configured to create the control data based on the building model data and the input data; and
an output interface configured to output the control data created by the processing device.

11. The information creation device of claim 10, wherein
the control data includes:
association information configured to associate one of pieces of identification information, which have been set uniquely for a plurality of devices that form the equipment, with at least another one of the pieces of identification information; and
state information indicating respective states of the plurality of devices,
the condition for creating as defined by the input data is a condition for creating contents of the association information and contents of the state information, and
the processing device is configured to set the identification information for the plurality of devices in virtual space comprised of the building model data, and create the contents of the association information and the contents of the state information in accordance with the condition for creating the control data.

12. An information creation system comprising:
an input/output (I/O) interface configured to receive building model data including information about architecture of a building and information about equipment of the building;
an input interface configured to receive input data in association with the building model data, the input data defining a condition for creating control data for controlling the equipment;
a processing device configured to create the control data based on the building model data and the input data; and
an output interface configured to output the control data created by the processing device.

13. The information creation system of claim 12, wherein
the control data includes:
association information configured to associate one of pieces of identification information, which have been set uniquely for a plurality of devices that form the equipment, with at least one of the pieces of identification information; and
state information indicating respective states of the plurality of devices,
the condition for creating as defined by the input data is a condition for creating contents of the association information and contents of the state information, and
the processing device is configured to set the identification information for the plurality of devices in virtual space comprised of the building model data, and create the contents of the association information and the contents of the state information in accordance with the condition for creating the control data.

14. An information creation system comprising:
the information creation device of claim 10; and
a simulator configured to simulate operation of the equipment based on the control data in virtual space built by a computer.
